(19) United States
(12) Patent Application Publication
(10) Pub. No.: US 2008/0048549 A1
(43) Pub. Date: Feb. 28, 2008

(54) Plasma display panel and method of manufacturing the same

(76) Inventors: Ho-Young Ahn, Suwon-si (KR); Won-Ju Yi, Suwon-si (KR); Kyong-Doo Kang, Suwon-si (KR); Dong-Young Lee, Suwon-si (KR); Soo-Ho Park, Suwon-si (KR); Seok-Gyun Woo, Suwon-si (KR); Jae-Ik Kwon, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/892,572

(22) Filed: Aug. 24, 2007

(30) Foreign Application Priority Data
Aug. 28, 2006 (KR) 10-2006-0081835

(51) Int. Cl. G09F 9/313; H01J 17/49; H01J 9/02

(52) U.S. Cl. 313/491; 313/582; 445/24

(57) ABSTRACT

Example embodiments relate to a plasma display panel and a method of forming the same, having a first substrate, a second substrate, a barrier rib interposed between the first substrate and the second substrate, a plurality of grooves formed in the second substrate so as to define discharge cells, a barrier rib electrode including a discharge portion located within the barrier rib to perform a discharge, a contact portion exposed from a surface of the barrier rib, and an intermediate portion connecting the discharge portion and the contact portion, and a terminal electrode on at least one of the first and second substrates such that one end of the terminal electrode may be electrically connected to a signal transmission element and other end thereof may be electrically connected to the contact portion of the barrier rib electrode.

### BACKGROUND OF THE INVENTION

1. Field of the Invention

Example embodiments relate to a display panel and a method of manufacturing the same. More particularly, to a plasma display panel for providing an electrical connection between a barrier rib electrode and a terminal electrode, and a method of manufacturing the same.

2. Description of the Related Art

Recently, plasma display panels (PDPs) have been widely used to replace conventional display devices, e.g., a cathode ray tube. In a PDP, a discharge voltage may be applied after a discharge gas is filled between two substrates on which a plurality of electrodes may be formed. Ultraviolet (UV) light may then be generated to excite a photoluminescent layer (e.g., a phosphor layer) formed in a specific pattern so as to form a desired image.

The PDP may generally include a pair of substrates facing each other, a plurality of electrodes interposed between the substrates, and a circuit board for driving the PDP.

The plurality of electrodes may perform a discharge when an external discharge voltage is applied. Because the electrodes may be electrically connected to a terminal electrode formed on the substrates, the discharge voltage may be supplied from a signal transmitting element connected to the terminal electrode so as to perform the discharge.

In order to increase the discharge efficiency, the electrodes performing the discharge may be formed within barrier ribs. Because the heights of the barrier rib electrodes located within the barrier ribs may be different from that of the terminal electrode disposed on the substrate, the connection between the barrier rib electrode and the terminal electrode may not be completely secure and easily attainable. Accordingly, mis-connection between the barrier rib electrode and terminal electrode may cause errors when assembling or operating the PDP. Therefore, there may be a need for developing the PDP having an electrode connection structure suitable for solving the above-mentioned problem.

### SUMMARY OF THE INVENTION

Example embodiments are therefore directed to a display panel, which substantially overcome one or more of the problems due to the limitations and disadvantages of the related art.

It is therefore a feature of example embodiments to provide a plasma display panel in which a barrier rib electrode located within a barrier rib may be electrically connected to a terminal electrode.

It is therefore another feature of example embodiments to ensure an electrical connection between a barrier rib electrode formed on the barrier rib and a terminal electrode disposed on a second substrate.

It is therefore yet another feature of example embodiments to provide a plasma display panel having a discharge area that may be relatively larger.

It is therefore yet another feature of example embodiments to increase radiation brightness and discharge efficiency of the discharge area.

It is therefore yet another feature of example embodiments to provide a plasma display panel to reduce and/or eliminate any level difference (e.g., height) between a barrier rib electrode formed on a barrier rib and a terminal electrode disposed on a second substrate.

It is therefore yet another feature of example embodiments to provide a simpler manufacturing process.

It is therefore yet another feature of example embodiments to reduce manufacturing cost.

At least one of the above and other features of example embodiments may provide a plasma display panel having a first substrate, a second substrate, a barrier rib interposed between the first substrate and the second substrate, a plurality of grooves formed in the second substrate so as to define discharge cells, a barrier rib electrode including a discharge portion located within the barrier rib to perform a discharge, a contact portion exposed from a surface of the barrier rib, and an intermediate portion connecting the discharge portion and the contact portion, and a terminal electrode on at least one of the first and second substrates such that one end of the terminal electrode may be electrically connected to a signal transmission element and other end thereof may be electrically connected to the contact portion of the barrier rib electrode.

At least one of the above and other features of example embodiments may provide a method of manufacturing a plasma display panel. The method may include forming a first substrate and a second substrate, forming a barrier rib between the first substrate and the second substrate, forming a plurality of grooves in the second substrate so as to define discharge cells, forming a barrier rib electrode, the barrier rib electrode includes a discharge portion located within the barrier rib to perform a discharge, a contact portion exposed from a surface of the barrier rib, and an intermediate portion connecting the discharge portion and the contact portion, and forming a terminal electrode on at least one of the first and second substrates such that one end of the terminal electrode may be electrically connected to a signal transmission element and other end thereof may be electrically connected to the contact portion of the barrier rib electrode.

### BRIEF DESCRIPTION OF THE DRAWINGS

The above and other features and advantages of the example embodiments will become more apparent to those of ordinary skill in the art by describing in detail example embodiments thereof with reference to the attached drawings, in which:

FIG. 1 illustrates a partial exploded perspective view of a plasma display panel (PDP) according to an example embodiment;

FIG. 2 illustrates a cross-sectional view taken along line II-II of FIG. 1;

FIG. 3 illustrates a cross-sectional view of a connection between a barrier rib and a terminal electrode of FIG. 2;

FIG. 4 illustrates a schematic layout view of a discharging portion and a discharge cell of a barrier rib electrode of FIG. 1;

FIG. 5 illustrates a partial exploded perspective view of a plasma display panel (PDP) according to another example embodiment;

FIG. 6 illustrates a cross-sectional view taken along line VI-VI of FIG. 5; and

FIG. 7 illustrates a cross-sectional view o of a connection between a barrier rib and a terminal electrode of FIG. 6.

### DETAILED DESCRIPTION OF THE INVENTION

Korean Patent Application No. 10-2006-0081835, filed on Aug. 28, 2006, in the Korean Intellectual Property Office, and entitled: “Plasma Display Panel,” is incorporated herein in its entirety.

Example embodiments will now be described more fully hereinafter with reference to the accompanying drawings. The invention may, however, be embodied in different forms and should not be construed as limited to the embodiments set forth herein. Rather, these example embodiments are provided so that this disclosure will be thorough and complete, and will fully convey the scope of the invention to those skilled in the art.

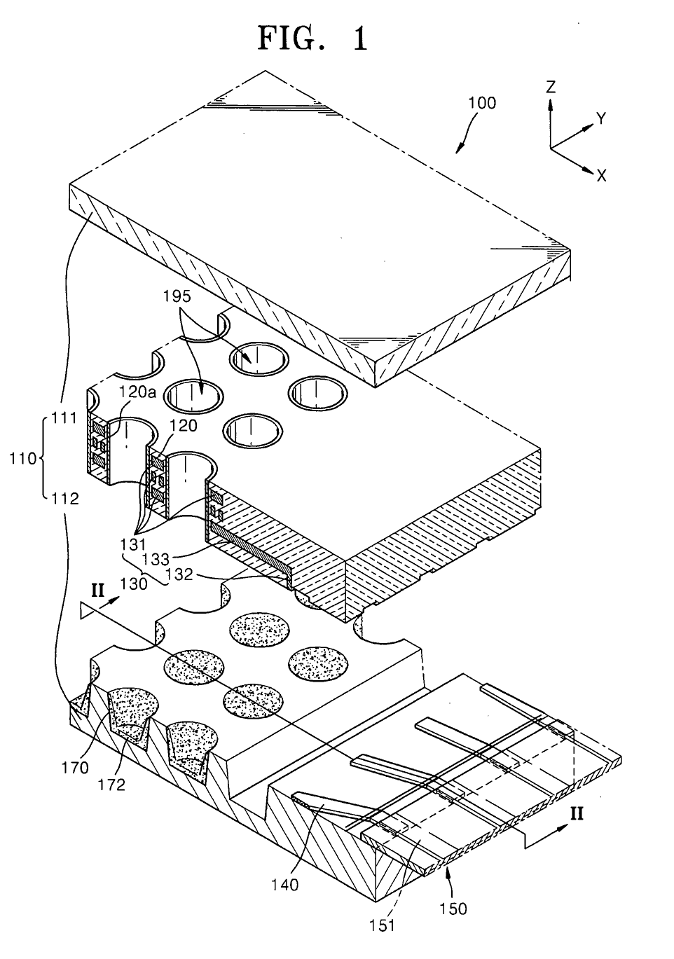

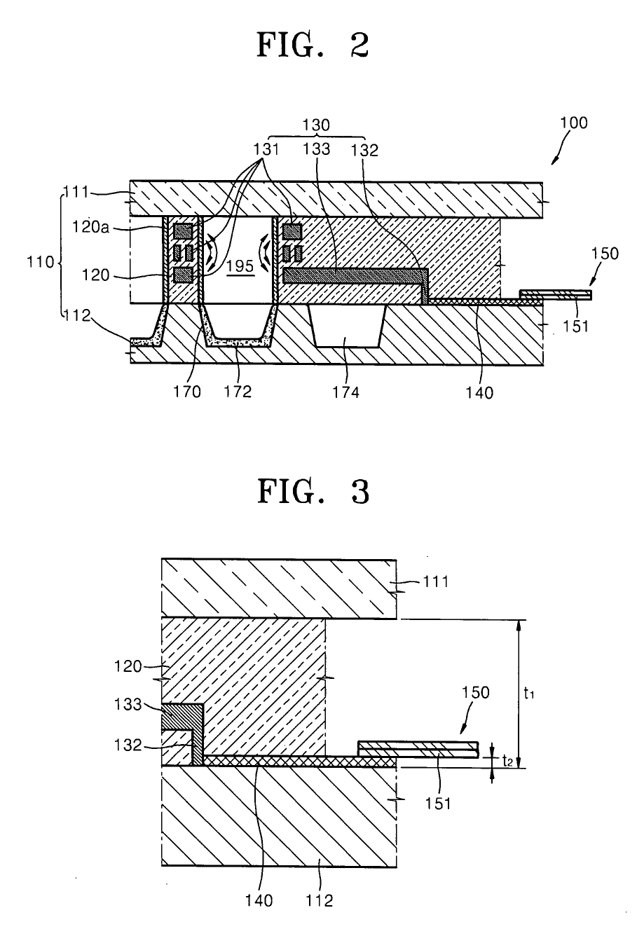

FIG. 1 illustrates a partial exploded perspective view of a plasma display panel (PDP) 100 according to an example embodiment. FIG. 2 illustrates a cross-sectional view taken along line II-II of FIG. 1. FIG. 3 illustrates a cross-sectional view of a connection between a barrier rib and a terminal electrode of FIG. 2.

Referring to FIGS. 1 and 2, the PDP 100 may include a pair of substrates 110, a barrier rib 120, a plurality of grooves 170, a barrier rib electrode 130, a terminal electrode 140, a signal transmission element 150, and a photoluminescent layer 172. It should be appreciated that other devices and/or components may be included (or excluded) in the PDP 100.

The pair of substrates 110 may include a first substrate 111 and a second substrate 112. The first substrate 111 and the second substrate 112 may face each other and may be spaced apart from each other by a distance. The first substrate 111 may be made of, for example, a transparent glass. It should be appreciated that the second substrate 112 may be similarly made as the first substrate 111. It should further be appreciated that the first and second substrates 111 and 112 may be formed from other transparent substrates, such as, but not limited to, a soda lime glass, a semi-transmissible substrate, a reflective substrate, or a colored substrate.

In an example embodiment, the first substrate 111 may be transparent so that a visible light, which may be generated when an electric discharge occur, may be transmitted through the first substrate 111. However, it should be appreciated that other substances may be used to form the first and second substrates 111 and 112. For example, the first substrate 111 may be opaque, while the second substrate 112 may be transparent, or the first substrate 111 and the second substrate 112 may both be transparent. Moreover, the first substrate 111 and the second substrate 112 may be made of a semi-transparent material, and a color filter may be placed on an external or internal surface thereof.

The barrier rib 120 may be interposed between the pair of substrates 110. The barrier rib 120, along with the groove 170 formed in the second substrate 112, may define a discharge cell 195 (where a discharge may occur). The barrier rib electrode 130 may be located within the barrier rib 120.

A dielectric material constituting the barrier rib 120 may prevent and/or reduce an electric current from being directly applied between the barrier rib electrode 130 when a sustain discharge occurs. The dielectric material may also prevent and/or reduce charged particles from being damaged due to a direct collision against the barrier rib electrode 130. Further, the dielectric material may accumulate wall charges by inducing the charged particles. Examples of the dielectric material may be at least one of a composition of a PbO, a B₂O₃ and a SiO₂.

The barrier rib 120 may be a sheet-like structure interposed between the first substrate 111 and the second substrate 112. The barrier rib 120 may be laminated in order to construct the barrier rib 120 as the sheet-like structure. The lamination process may include a plurality of dielectric sheets, on which the barrier rib electrodes 130 may be formed in a predetermined pattern. A punching process may then be carried out on a portion where the discharge cells 195 may be arranged, thereby forming a discharge space for the discharge cells 195.

Although the above example embodiments describe the barrier rib 120 having the sheet-like structure, it should be appreciated that other structures may be employed. For example, instead of independently forming the sheet-like structure, the barrier rib 120 may be formed with the second substrate 112, such that the barrier rib 120 may be laminated on the second substrate 112 by using a printing method or the like.

The groove 170 may be formed in the second substrate 112. The groove 170 may define the discharge cell 195 along with the pair of substrates 110 and the barrier rib 120. The groove 170 may be directly formed in the second substrate 112 by using an etching method or the like. The photoluminscent layer 172 may be located in the groove 170, which may be in contact with the discharge cell 195.

The barrier rib 120 and the groove 170 may define the discharge cell 195, thereby defining a display area where an image may be realized. It should be appreciated that other arrangements may be employed to form the display area. For example, a dummy discharge cell 174 may be provided in the display area. The dummy discharge cell 174 may be an area where the electrode or the photoluminescent layer 172 may not be disposed and/or where a discharge may not be carried out. The dummy discharge cell 174 may be located between (or adjacent to) the discharge cells 195.

The discharge cell 195 defined by the barrier rib 120 and the groove 170 may have a shape of a circle (as shown in FIGS. 1 and 2) in a horizontal cross-section. However, it should be appreciated that the discharge cell 195 may have various other shapes, such as, but not limited to, a polygonal shape (e.g., a triangular shape, a rectangular shape, a pentagonal shape, etc.) and an elliptical shape.

Each lateral side of the barrier rib 120 in contact with the discharge cell 195 may be covered by a passivation layer 120a. The passivation layer 120a may be made of, for example, magnesium oxide (MgO). It should be appreciated that the passivation layer 120a may be made from other materials. The passivation layer 120a may prevent and/or reduce the barrier rib 120 from being damaged due to a sputtering process of plasma particles. Further, the passivation layer 120a may reduce a discharge voltage by emitting secondary electrons.

Further, the dummy discharge cell 174 may be formed as a dummy barrier rib (not shown) on the second substrate 112, which may be formed outside of the groove 170. The dummy barrier rib may be provided on one lateral side of the dummy discharge cell 174 formed on the second substrate 112 so as to protect the groove 170, which may be inwardly disposed.

Referring back to FIGS. 1 and 2, the barrier rib electrode 130 may include a discharging portion 131, a contact portion 132 and an intermediate portion 133. The discharging portion 131 may be disposed within the barrier rib 120 so as to perform a discharge, and may surround the discharge cell 195. The contact portion 132 may also be disposed within the barrier rib 120, and may be exposed from a surface of the barrier rib 120 (e.g., the surface being located between the barrier rib 120 and the second substrate 112). The intermediate portion 133 may connect the discharging portion 131 and the contact portion 132. The discharging portion 131, the intermediate portion 133, and the contact portion 132 may be integrally formed to constitute the barrier rib electrode 130. Alternatively, each of the discharging portion 131, the intermediate portion 133, and the contact portion 132 may also be separately formed.

The contact portion 132 may extend through the barrier rib 120, and may extend to a surface where the barrier rib 120 may come in contact with the second substrate 112, e.g., the contact portion 132 may be extended so as to be exposed through the surface of the barrier rib 120 facing the second substrate 112. Alternatively, the contact portion 132 may be extended to the same level (e.g., plane) as the surface of the barrier rib 120, so that an end of the contact portion 132 may be exposed, and electrically connected to the terminal electrode 140. Accordingly, because one end of the contact portion 132 may be on the same plane as the barrier rib 120, the contact portion 132 and the terminal electrode 140 may be connected with each other.

The thickness of the terminal electrode 140 may have to be accurately measured so that any disconnection caused by a difference in height may be avoided. Referring to FIG. 3, the barrier rib 120 may be electrically connected to the terminal electrode 140 at the same level with the contact portion 132, because the terminal electrode 140 disposed on the second substrate 112 may have a thickness t2 within a thickness t1 of the barrier rib 120. In this example embodiment, because a portion corresponding to the thickness t2 of the terminal electrode 140 may be electrically connected with the end of the contact portion 132, the terminal electrode 140 of the barrier rib 120 may be directly connected to the contact portion 132.

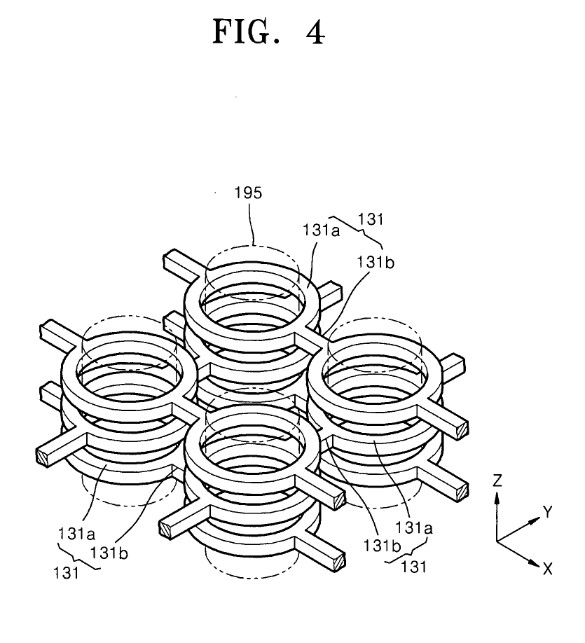

FIG. 4 illustrates a schematic layout view of the discharging portion 131 and the discharge cell 195 of the barrier rib electrode 130 of FIG. 1. Referring to FIG. 4, the discharging portion 131 of the barrier rib electrode 130 may be extended so as to surround the discharge cells 195. Further, the discharging portion 131 may include a loop portion 131a surrounding the discharge cells 195, and a loop connection portion 131b.

The discharging portion 131 of the barrier rib electrode 130 may include a circular loop portion 131a, however, it should be appreciated that a portion surrounding the discharge cells 195 of the discharging portion 131 may be formed in various shapes, such as, but not limited to, an elliptical ring, a polygonal ring, or a C-shaped ring having an open portion.

The discharging portion 131 of the barrier rib electrode 130 may surround the discharge cell 195, and thus, a sustain discharge may vertically occur in every direction where the discharge cell 195 may be defined. However, it should be appreciated that other structures may be employed to form the discharging portion 131. For example, the discharging portion 131 of the barrier rib electrode 130 may be buried in the barrier rib 120 in a stripe-like manner. In this case, the discharging portion 131 of the barrier rib electrode 130 may have a discharge path for an opposite discharge, instead of a surface discharge.

Because the discharging portion 131 of the barrier rib electrode 130 may be located within the barrier rib 120, the discharging portion 131 does not have to be a transparent electrode. As such, the discharging portion 131 may be made of a metal material that may have excellent conductivity and low resistance, such as, but not limited to, silver (Ag), aluminum (Al), or copper (Cu). It should be appreciated that other materials may be employed to form the discharging portion 131. Accordingly, the discharging portion 131 may provide many advantages, such as, but not limited to, a faster response rate for a discharge, a lower signal distortion, and/or a reduced power consumption required for a sustain discharge.

The barrier rib electrode 130 may have a three-electrode structure such that a barrier rib 120 may be interposed between two sustain electrodes to perform only an address function. Alternatively, the electrode lines may also be disposed at upper and lower sides so as to symmetrically cross each other, and thus, the address function may be also achieved.

As similarly discussed above, the contact portion 132 may be disposed at a lower edge of the barrier rib 120 so as to ensure that the end of the contact portion 132 may electrically come in contact with the terminal electrode 140. The discharging portion 131 and the contact portion 132 may be electrically connected with each other via the intermediate portion 133. The intermediate portion 133 may be located within the barrier rib 120. One end of the terminal electrode 140 may be connected to the contact portion 132, and other end thereof may be connected to the signal transmission element 150. The terminal electrode 140 may be formed on the second substrate 112.

The terminal electrode 140 may be formed on the second substrate 112, however, it should be appreciated that the terminal electrode 140 may be formed on the inner surface of the first substrate 111. In this case, the groove 170 and the dummy discharge cell 174 may be disposed on the first substrate 111, and the contact portion 132 of the barrier rib electrodes 130 may be disposed at an upper part of a first barrier rib. Alternatively, it should further be appreciated that the terminal electrode 140 may also be on at least one of the first and second substrates 111 and 112.

The signal transmission element 150 may be electrically connected to a driving circuit board (not shown), which may drive the PDP 100. The signal transmission element 150 may be, for example, but not limited to, a flexible printed cable (FPC) and a tape carrier package (TCP). The signal transmission element 150 may include wires 151 transmitting electrical signals. Each of the wires 151 may be electrically connected to the terminal electrode 140, and may be spaced apart from one another by a distance. Further, the wire 151 may be connected to the terminal electrode 140 by using an anisotropic conductive film, for example.

The photoluminescent layer 172 may have a component that may generate a visible light in response to ultraviolet (UV) light. The photoluminescent layer 172 may include a red phosphor layer emitting red visible light, e.g., a phosphor of Y(V,P)O₄:Eu; a green phosphor layer emitting green visible light, e.g., a phosphor of Zn₂SiO₄:Mn; and a blue phosphor layer emitting blue visible light, e.g., a phosphor of BAM:Eu.

The photoluminescent layer 172 may be formed inside the groove 170 of the second substrate 112, however, it should be appreciated that the photoluminescent layer 172 may be formed at any portions of the discharge cells 195, e.g., the groove 170 of the first barrier rib, as long as the photoluminescent layer 172 is located within a discharge space and emits visible light in response to the UV light generated by a plasma discharge.

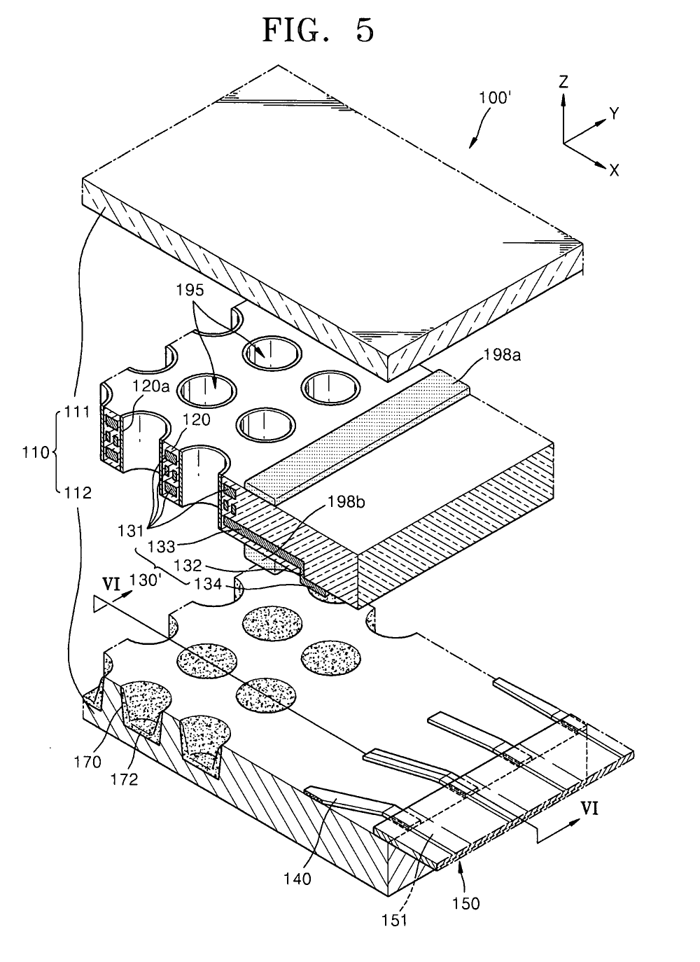

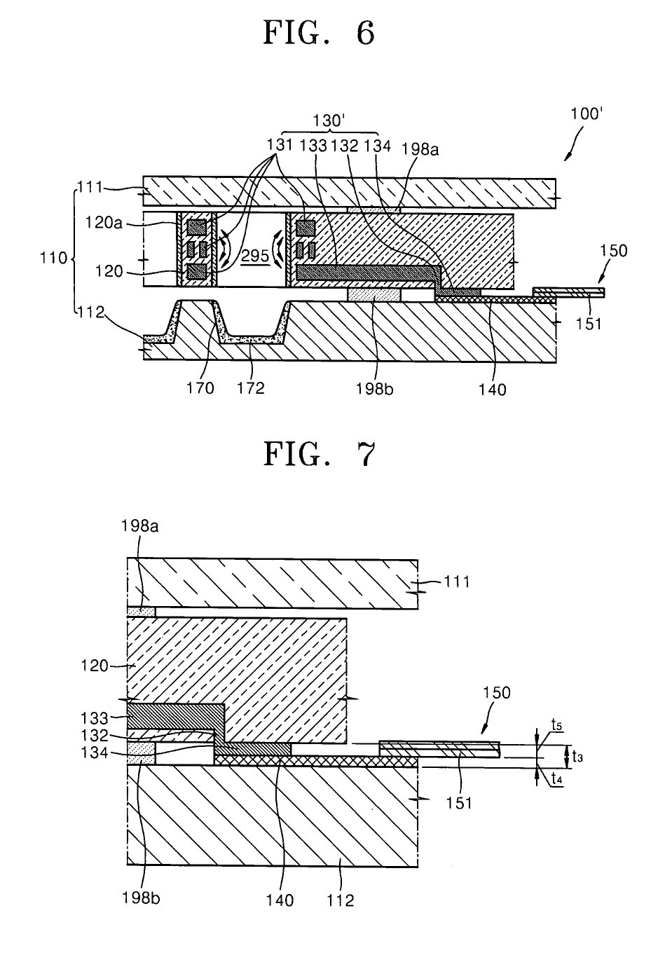

FIG. 5 illustrates a partially exploded perspective view of a PDP 100′ according to another embodiment. FIG. 6 illustrates a cross-sectional view taken along line VI-VI of FIG. 5. FIG. 7 illustrates a cross-sectional view of a connection between a barrier rib and a terminal electrode of FIG. 6. Like reference numerals as referenced in FIGS. 1-4 will denote like elements.

Referring to FIG. 5, upper and lower sealants 198a, 198b (e.g., frits) may be positioned between the first substrate 111 and the barrier rib 120, and between the second substrate 112 and the barrier rib 120, respectively. The upper and lower sealants 198a, 198b may seal the PDP 100 through an annealing process, for example.

After being sealed, the PDP 100 may be filled with a discharge gas, such as, but not limited to, neon (Ne), xenon (Xe), helium (He) and a mixture thereof, in a discharge cell.

When providing the upper sealant 198a, a space may exist between the barrier rib 120 and the first substrate 111 in accordance to a thickness of the upper sealant 198a. Further, as similarly provided, a space may also exist between the barrier rib 120 and the second substrate 112 in accordance to a thickness of the second sealant 198b. As a result, exhaustion of gas(es) may be performed through the spaces formed by the upper and lower sealants 198a, 198b.

Referring to FIGS. 6 and 7, a barrier rib electrode 130′ may include the discharging portion 131, the contact portion 132 and intermediate portions 133 and 134. The discharging portion 131 may be disposed within the barrier rib 120 so as to perform a discharge. The contact portion 132 may be exposed from the surface of the barrier rib 120 between the barrier rib 120 and the second substrate 112. Further, in the space formed by the lower sealant 198b, the contact portion 132 of a barrier rib electrode 130 may come in contact with the terminal electrode 140 so as to be electrically connected.

The intermediate portion 133 may connect the discharging portion 131 to the contact portion 132. The intermediate portion 134 may further connect the contact portion 132 to the terminal electrode 140, i.e., may increase a surface area of electrical contact between the barrier rib electrode 130′ and the terminal electrode 140. It should be appreciated that the intermediate portions 133 and 134 may be optionally bent. The discharging portion 131, the intermediate portions 133 and 134, and the contact portion 132 may be integrally formed so as to constitute the barrier rib electrode 130. Alternatively, each of the discharging portion 131, the intermediate portions 133 and 134, and the contact portion 132 may also be separately formed.

The contact portion 132 may extend between the intermediate portions 132 and 134, and may protrude into a space between the barrier rib 120 and the second substrate 112 so as to be exposed. Further, the contact portion 132 may extend between the barrier rib 120 and the second substrate 112, along the surface of the barrier rib 120. One end of the terminal electrode 140, which may electrically connect the contact portion 132 to a signal transmitting element 150, may be placed below the contact portion 132, and may be laminated to be electrically connected to the contact portion 132. In this example embodiment (as shown in FIG. 7), when the upper sealant 198a may be interposed between the barrier rib 120 and the first substrate 111, and the lower sealant 198b may be interposed between the barrier rib 120 and the second substrate 112, a thickness t3 of the lower sealant 198b interposed between the barrier rib 120 and the second substrate 112 may be equal to the total thicknesses of a thickness t5 of the contact portion 132 extending beyond the barrier rib 120, e.g., a thickness t5 of the intermediate portion 134, and a thickness t4 of the terminal electrode 140. Thus, the contact portion 132 and the terminal electrode 140 may not be disconnected from each other, but may be completely connected with each other in the space formed by the lower sealant 198b.

In an alternative example embodiment, the contact portion 132 and the terminal electrode 140 do not have to overlap in order to be laminated and electrically connected. Thus, the contact portion 132 may be electrically connected to the terminal electrode 140, while a lateral side of the contact portion 132 and a lateral side of the terminal electrode 140 may be disposed on the second substrate 112 at the same level with each other.

Now, the operation of the PDP 100 according to an example embodiment will be described in detail.

When assembling the PDP 100, a discharge gas may be filled therein. Thereafter, a specific address voltage may be supplied between the discharging portions 131 of the barrier rib electrode 130 from an external power source via the signal transmitting element 150, the terminal electrode 140 and the contact portion 132. As such, an address discharge may occur, so that the discharge cell 195 in which a sustain discharge may occur due to the address discharge may be selected.

Next, a specific discharge sustain voltage may be supplied between the discharging portions 131 of the barrier rib electrode 130 via the signal transmitting element 150, the terminal electrode 140 and the contact portion 132. Accordingly, a sustain discharge may occur due to a movement of wall charges, and an energy level of the discharge gas that may be excited when the sustain discharge occur may be lowered. As a result, UV light may be emitted.

Then, the UV light may excite the photoluminescent layer 172 within the discharge cell 195. When the energy level of the excited photoluminescent layer 172 is lowered, visible light may be emitted. The emitted visible light may be transmitted through the first substrate 111, thereby forming an image that may be recognized by a user.

The groove 170 may be formed in the second substrate 112, and the photoluminescent layer 172 may be formed in the groove 170. As such, a second barrier rib does not have to include an additional photoluminescent layer in addition to the barrier rib 120. Therefore, the barrier rib 120 may completely contact the second substrate 112, (or may be spaced apart from the second substrate 112 by a thickness of the lower sealant 198b), so as to ensure a connection between the contact portion 132 of the barrier rib electrode 130 within the barrier rib 120 and the terminal electrode 140 of the second substrate 112. This may result in an improved electrode connection.

Further, in the PDP 100 of example embodiments, the discharging portions 131 of the barrier rib electrode 130 may surround the discharge cell 195. Accordingly, because a sustain discharge may occur along all directions of the discharge cell 195, a discharge area may become relatively larger, so that a radiation brightness and discharge efficiency may increase.

Furthermore, because the barrier rib 120 of the PDP 100 of the example embodiment may have a sheet-like structure, the barrier rib 120 may be formed by forming only a generally rectangular hole in a space, thereby simplifying a manufacturing process and reducing a manufacturing cost.

Accordingly, in a PDP 100 of example embodiments, an additional barrier rib 120 may not be provided to form the photoluminescent layer 172. Instead, the photoluminescent layer 172 may be formed in the groove 170 formed on the second substrate 112. As a result, a level difference (e.g., height) between the barrier rib 120 and the additional barrier rib 120 may be reduced and/or eliminated, and thus, an electrical connection may be ensured between the barrier rib electrode 130 formed on the barrier rib 120 and the terminal electrode 140 disposed on the second substrate 112.

Further, the PDP 100 of example embodiments may be constructed such that a discharge portion 131 of the barrier rib electrode 130 may be buried inside the barrier rib 120, and thus, surrounding the discharge cell 195. As a result, a discharge area may become relatively larger, and a radiation brightness and discharge efficiency may increase.

Further, a manufacturing process may be simpler because a protruding barrier rib may not have to be additionally formed on the second substrate 112.

Further, a barrier rib of the PDP 100 of example embodiments may have a sheet structure, and thus, simplifying manufacturing process and reducing manufacturing cost.

In the figures, the dimensions of layers and regions may be exaggerated for clarity of illustration. It will also be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Further, it will be understood that when a layer is referred to as being “under” or “above” another layer, it can be directly under or directly above, and one or more intervening layers may also be present. In addition, it will also be understood that when a layer is referred to as being “between” two layers, it can be the only layer between the two layers, or one or more intervening layers may also be present. Like numbers refer to like elements throughout. As used herein, the term “and/or” includes any and all combinations of one or more of the associated listed items.

It will also be understood that, although the terms “first” and “second” etc. may be used herein to describe various elements, structures, components, regions, layers and/or sections, these elements, structures, components, regions, layers and/or sections should not be limited by these terms. These terms are only used to distinguish one element, structure, component, region, layer and/or section from another element, structure, component, region, layer and/or section. Thus, a first element, structure, component, region, layer or section discussed below could be termed a second element, structure, component, region, layer or section without departing from the teachings of example embodiments.

Spatially relative terms, such as “beneath,” “below,” “lower,” “above,” “upper” and the like, may be used herein for ease of description to describe one element or feature relationship to another element(s) or feature(s) as illustrated in the figures. It will be understood that the spatially relative terms are intended to encompass different orientations of the device in use or operation in addition to the orientation depicted in the figures. For example, if the device in the figures is turned over (or upside down), elements or layers described as “below” or “beneath” other elements or layers would then be oriented “above” the other elements or layers. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Example embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed:

1. A plasma display panel, comprising:
a first substrate;
a second substrate;
a barrier rib interposed between the first substrate and the second substrate;
a plurality of grooves formed in the second substrate so as to define discharge cells;
a barrier rib electrode including a discharge portion located within the barrier rib to perform a discharge, a contact portion exposed from a surface of the barrier rib, and a first intermediate portion connecting the discharge portion and the contact portion; and
a terminal electrode on at least one of the first and second substrates such that one end of the terminal electrode is electrically connected to a signal transmission element and other end thereof is electrically connected to the contact portion of the barrier rib electrode

2. The plasma display panel as claimed in claim 1, wherein the barrier rib is laminated in a sheet-like form.

3. The plasma display panel as claimed in claim 1, wherein a lateral side of the barrier rib in contact with the discharge cell is covered with a passivation layer.

4. The plasma display panel as claimed in claim 1, wherein the contact portion extends to the surface where the barrier rib comes in contact with the second substrate.

5. The plasma display panel as claimed in claim 1, further comprising a dummy discharge cell, the dummy discharge cell is formed on the second substrate.

6. The plasma display panel as claimed in claim 1, wherein the discharge portion surrounds at least a portion of a circumference of the discharge cells.

7. The plasma display panel as claimed in claim 4, wherein an end of the contact portion and the terminal electrode are located on a same plane of the second substrate, and are electrically connected with each other.

8. The plasma display panel as claimed in claim 1, wherein the signal transmission element is connected to the terminal electrode by an anisotropic conductive film.

9. The plasma display panel as claimed in claim 1, further comprising a photoluminescent layer located in the discharge cell, the photoluminescent layer is formed in the grooves of the second substrate.

10. The plasma display panel as claimed in claim 1, further comprising:
a first sealant between the first substrate and the barrier rib; and
a second sealant between the second substrate and the barrier rib.

11. The plasma display panel as claimed in claim 10, wherein a thickness of the second sealant is equal to a total thickness of an electrical connection portion of the contact portion and the terminal electrode.

12. The plasma display panel as claimed in claim 1, wherein the signal transmission element includes a wire attached thereto.

13. The plasma display panel as claimed in claim 1, wherein the signal transmission element is at least one of a flexible printed cable and a tape carrier package.

14. The plasma display panel as claimed in claim 1, wherein
the contact portion exposed from the surface of the barrier rib extends between the barrier rib and a substrate surface of one of the first and second substrates, and
the terminal electrode is on the substrate surface.

15. The plasma display panel as claimed in claim 14, wherein the contact portion extends to the surface where the barrier rib comes in contact with the substrate surface.

16. The plasma display panel as claimed in claim 15, wherein the terminal electrode is electrically connected directly to the contact portion on the substrate surface.

17. The plasma display panel as claimed in claim 1, wherein the barrier rib electrode further comprises a second intermediate portion, the second intermediate portion is between the barrier rib and the terminal electrode, and connects the contact portion to the terminal electrode.

18. A method of manufacturing a plasma display panel, comprising:
forming a first substrate and a second substrate;
forming a barrier rib between the first substrate and the second substrate;
forming a plurality of grooves in the second substrate so as to define discharge cells;
forming a barrier rib electrode, the barrier rib electrode includes a discharge portion located within the barrier rib to perform a discharge, a contact portion exposed from a surface of the barrier rib, and an intermediate portion connecting the discharge portion and the contact portion; and
forming a terminal electrode on at least one of the first and second substrates such that one end of the terminal electrode is electrically connected to a signal transmission element and other end thereof is electrically connected to the contact portion of the barrier rib electrode.

19. The method as claimed in claim 18, further comprising a photoluminescent layer located in the discharge cells.

20. The method as claimed in claim 18, wherein the contact portion extends to the surface where the barrier rib comes in contact with the second substrate, and an end of the contact portion and the terminal electrode are located on a same plane of the second substrate to electrically connect with each other.
